(19) United States
(12) Patent Application Publication
(10) Pub. No.: US 2003/0024251 A1
(43) Pub. Date: Feb. 6, 2003

(54) Method and device for a cooling system

(76) Inventors: Bruno Ziegler, Pfungen (CH); Robert Sebastianutto, Schwerzenbach (CH); Juergen Clausen, Konstanz (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/175,154

(22) Filed: Jun. 20, 2002

(30) Foreign Application Priority Data
Jun. 20, 2001 (DE) DE 101 29 780.7

(51) Int. Cl. F17C 7/04; F17C 9/02

(52) U.S. Cl. 62/48.1

(57) ABSTRACT

A method for a cooling system operates by vaporizing liquid nitrogen at sub-atmospheric pressure subsequently compressing and then warming the vaporized nitrogen. A device for a cooling system which operates by vaporizing liquid nitrogen at sub-atmospheric pressure subsequently compressing and then warming the vaporized nitrogen has a pressure venting or metering device, which serves the pressure venting or metering of the liquid nitrogen, a container, in which the released nitrogen is conducted and from which refrigeration is discharged to at least one refrigeration consumer, a heat exchanger which serves the super cooling of the liquid nitrogen and the warming of the vaporized nitrogen, and a compressor, which serves the compression of the vaporized nitrogen.

This application claims the priority of German Patent Document DE 101 29 780.7, filed Jun. 20, 2001, the disclosure of which is expressly incorporated by reference herein.

### BACKGROUND AND SUMMARY OF THE INVENTION

The invention relates to a cooling system which operates by vaporization of liquid nitrogen at sub-atmospheric pressure and subsequent warming and compression of the vaporized nitrogen.

Further, the invention relates to a device for a cooling system which operates by the vaporization of liquid nitrogen at sub-atmospheric pressure and subsequent warming and compression of the vaporized nitrogen, with a pressure venting or metering device, which serves the pressure venting or metering of the liquid nitrogen, a container, into which the vented nitrogen is conducted and from which the cold is discharged to at least one refrigeration user, a heat exchanger, which serves the warming of the vaporized nitrogen, and a compressor, which is used to compresses the vaporized nitrogen.

Generic methods or devices for cooling systems are used, for example, for open and closed cooling processes to cool high temperature, super-conductive components. The components that are to be cooled are either integrated directly in the above-mentioned container or supplied with refrigeration from this container via a secondary circuit.

There are two basic possibilities for achieving temperatures below the boiling point of nitrogen. First, a refrigerant which has a lower boiling point than nitrogen can be used, for example, neon or helium. Second, nitrogen can be vaporized at sub-atmospheric pressure, warming it roughly to the ambient temperature and subsequently compressing it to atmospheric or hyperbaric pressure.

### BRIEF DESCRIPTION OF THE DRAWINGS

FIG. 1 depicts a diagrammatic view of a conventional cooling system;

FIG. 2 depicts a diagrammatic view of one embodiment of a cooling system according to the present invention; and

FIG. 3 depicts a diagrammatic view of a further embodiment of a cooling system according to the present invention.

Other objects, advantages and novel features of the present invention will become apparent from the following detailed description of the invention when considered in conjunction with the accompanying drawings.

### DETAILED DESCRIPTION OF THE DRAWINGS

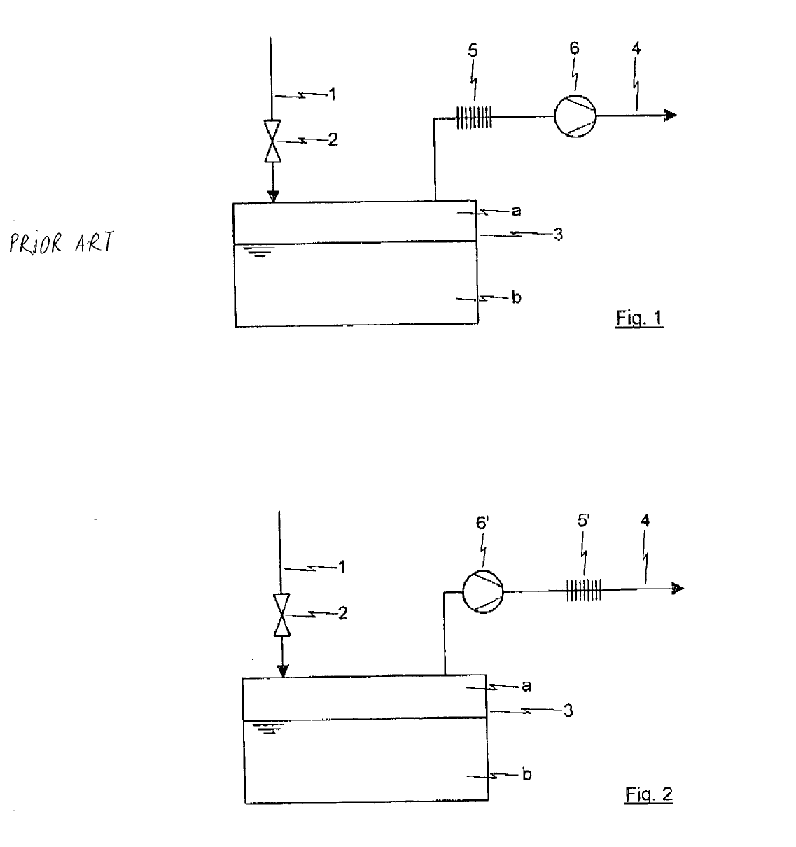

The novel features of the present invention may be best understood and appreciated after considering a conventional cooling system. As shown in FIG. 1, nitrogen is condensed along line 1 in an expansion or metering device which, preferably, is an expansion valve 2. The nitrogen is then subjected to pressure venting and fed to a container 3. There, a gaseous phase a and a liquid phase b are formed since the emission of cooling power causes the liquid nitrogen that is fed to the container to vaporize. The vaporized nitrogen is removed from the container 3 via line 4, and, upon warming to the ambient temperature in the heat exchanger 5, is compressed with the compressor 6 to atmospheric or hyperbaric pressure. Warming of the vaporized nitrogen in the heat exchanger 5 preferably occurs through interaction with the surrounding air, water, or the like, or through electric heating. While this cooling system may be suitable for some uses, an improved system and device would be an advance in the art.

It is an objective of the present invention to provide a method as well as a device for a cooling system, which may exhibit energy-related and device-related advantages compared to the above-described process for a cooling system through the vaporization of liquid nitrogen.

According to the invention, this objective is accomplished when the vaporized nitrogen is initially compressed and subsequently warmed, if necessary.

Compressors suitable for the inventive method may be conventional vacuum pumps, compressors, or other similar devices. Pursuant to the present invention, the compressor is arranged before the heat exchanger. While the term heat exchanger is used, and a heat exchanger may be preferred because it can serve a dual purpose, any device capable of warming the compressed nitrogen may be used.

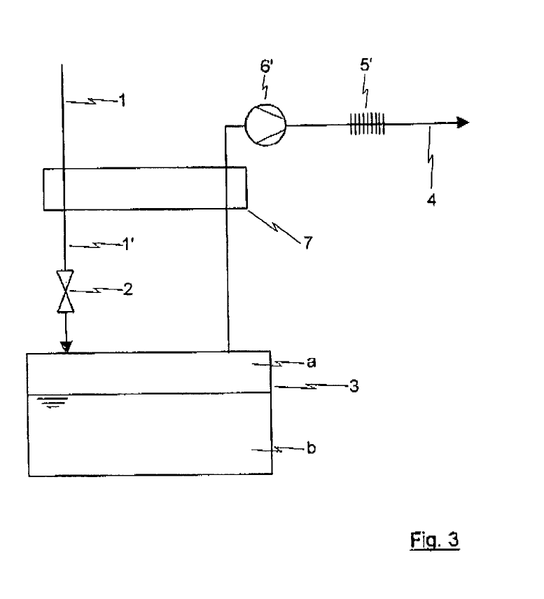

The inventive method and the inventive device for a cooling system through the vaporization of liquid nitrogen, as well as additional designs for the same, will be explained in more detail in conjunction with the embodiments shown in FIGS. 2 and 3.

In contrast to the processes based on the conventional system shown in FIG. 1, FIGS. 2 and 3 show a novel system where vaporized nitrogen is removed from the container 3, and is compressed in the compressor 6′. Compression in the compressor 6′ occurs prior to warming to the ambient temperature in the heat exchanger 5′.

One or several cold compressors can be used as the compressor 6′. Because a device, according to the present invention, locates the compressor 6′ before the heat exchanger, compression occurs at the boiling temperature of the nitrogen instead of at the ambient temperature.

An example of an appropriate cold compressor is a turbo-compressor of a radial type. Radial-type turbo-compressors can be designed specifically for use at very low temperatures.

In the embodiment shown in FIG. 3, one additional heat exchanger 7, is arranged before the cold compressor 6′. This heat exchanger 7 provides the super cooling of the liquid nitrogen in the line 1 by using the temperature differential of the vaporized nitrogen that has been removed from the container 3. This process not only super-cools the liquid nitrogen, it also slightly warms the vaporized nitrogen in line 1. Nitrogen that has been super cooled this way in heat exchanger 7 is subsequently fed to the expansion valve 2 via the line 1′.

The inventive method and the inventive device thereby lead to a reduction in the driving power of the compressor 6′ since compression takes place at low temperatures. Heat exchanger 5′ can therefore be of a smaller design Optionally, heat exchanger 5′ can be completely omitted.

A further benefit, according to the present invention, provides that smaller compressors may be utilized for the compression of nitrogen at sub-atmospheric pressure. This is due to the lower intake temperature and consequent greater density of the nitrogen when it reaches the compressor.

Yet another benefit of the present invention is the operation and maintenance of fewer devices, instruments, etc. at sub-atmospheric pressure. This benefit reduces the likelihood of contamination of the process gas through leakage, which is particularly important for a closed process. This may also provide cost savings in construction and operation.

The inventive method and the inventive device for a cooling system thus lead to a simplification of the process, a cost reduction, an increase in process efficiency, and an improvement of the operating safety as well as availability.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is

1. A method for operating a cooling system, comprising:
vaporizing liquid nitrogen at sub-atmospheric pressure; and
subsequently compressing the vaporized nitrogen prior to any temperature modification.

2. A method according to claim 1, further comprising warming the compressed nitrogen.

3. A method according to claim 1, further comprising using said vaporized nitrogen to super-cool liquid nitrogen prior to compression of said vaporized nitrogen.

4. A method according to claim 1, wherein compression of the vaporized nitrogen occurs through the use of at least one cold compressor.

5. A device for a cooling system which operates by vaporizing liquid nitrogen at sub-atmospheric pressure and subsequently compressing the vaporized nitrogen, comprising:
one of a pressure venting device and a metering device for forming vaporized nitrogen,
a container for conducting said vaporized nitrogen,
a heat exchanger for super cooling the liquid nitrogen and warming said vaporized nitrogen, and
a compressor for compressing said vaporized nitrogen,
wherein said compressor is arranged upstream of said heat exchanger,
wherein said heat exchanger can be omitted or circumvented with a bypass line, and
wherein refrigeration is discharged from said container to at least one refrigeration customer.

6. A device according to claim 5, wherein said heat exchanger is upstream of said compressor.

7. A device according to claim 5, wherein said compressor is a cold compressor.

8. A device for a cooling system which vaporizes liquid nitrogen at sub-atmospheric pressure and subsequently compresses the vaporized nitrogen, comprising:
one of an expansion device or a metering device;
a container in fluid communication with said one of said expansion device or said metering device; and
a compressor in fluid communication with and immediately downstream from said container;
wherein liquid nitrogen is condensed in said one of said expansion device or said metering device;
wherein said condensed nitrogen passes from said one of said expansion device or said metering device to said container; and
wherein the gaseous phase of said condensed nitrogen passes from said container to said compressor.

9. A device according to claim 8, further comprising a heat exchanger in fluid communication with said compressor, wherein compressed nitrogen passes from said compressor to said heat exchanger.

10. A device according to claim 9, further comprising a bypass line between said compressor and said heat exchanger.

11. A device according to claim 8, wherein said compressor comprises at least one cold compressor.

12. A device according to claim 8, wherein said one of said expansion device or said metering device comprises an expansion valve.

13. A device according to claim 9, wherein said heat exchanger is also in communication with the device in a region upstream from said one of said expansion device or said metering device.

14. A device according to claim 13, wherein said heat exchanger utilizes vaporized nitrogen passing between said container and said compressor to cool liquid nitrogen before said liquid nitrogen enters said one of said expansion device or said metering device.

15. A system for processing nitrogen, comprising:
means for vaporizing liquid nitrogen; and
means for compressing the vaporized nitrogen prior to any temperature modification.

16. A system according to claim 15, wherein said means for vaporizing liquid nitrogen comprises an expansion valve.

17. A system according to claim 15, wherein said means for compressing comprises at least one cold compressor.

18. A system according to claim 15, further comprising means for heating disposed downstream from said means for compressing.

19. A system for processing nitrogen, comprising:
a liquid nitrogen vaporizer; and
a vaporized nitrogen compressor provided downstream from said liquid nitrogen vaporizer,
wherein the region of the system between said liquid nitrogen vaporizer and said vaporized nitrogen compressor does not contain a heat exchanger.

20. A system according to claim 19, further comprising a heat exchanger provided downstream from said vaporized nitrogen compressor.
